(19) United States
(12) Patent Application Publication
(10) Pub. No.: US 2021/0088728 A1
(43) Pub. Date: Mar. 25, 2021

(54) 3D PRINTED FIBER OPTIC CONNECTOR END FACE AND METHOD OF MANUFACTURE

(71) Applicant: COMMSCOPE TECHNOLOGIES LLC, Hickory, NC (US)

(72) Inventors: Jan WATTÉ, Grimbergen (BE); Salvatore TUCCIO, Leuven (BE); Vivek PANAPAKKAM VENKATESAN, Leuven (BE); Koen VANMOL, Vilvoorde (BE); Jürgen Albert Jan VAN ERPS, Tervuren (BE); Hugo THIENPONT, Gooik (BE); Yolanda Justo ZARRAQUINOS, Etterbeek, Brussels (BE); Roland Simon H. CLAES, Dendermonde (BE); Saurav KUMAR, Gent (BE)

(21) Appl. No.: 16/975,087

(22) PCT Filed: Feb. 22, 2019
(86) PCT No.: PCT/US2019/019147

§ 371 Date: Aug. 21, 2020

Related U.S. Application Data
(60) Provisional application No. 62/634,480, filed on Feb. 23, 2018.

(51) Int. Cl. G02B 6/24; B33Y 80/00; B29D 11/00

(52) U.S. Cl. CPC G02B 6/241; B33Y 10/00; B29D 11/0075; B33Y 80/00

(57) ABSTRACT

A tapered core structure is written on the end of an optical fiber using a 3D-printing process. The tapered core may expand the mode diameter for improved coupling between fibers or may reduce the mode diameter to enhance coupling to a waveguide smaller than the fiber core. The written core is surrounded by a cladding. The diameter of the core is varied while it is being written, allowing a wide range of taper profiles to be implemented. The 3D-printing process is readily adapted to permit multiple fibers to have tapered cores written on their ends during the same process cycle.

### CROSS-REFERENCE TO RELATED APPLICATION

This application is being filed on Feb. 22, 2019 as a PCT International Patent Application and claims the benefit of U.S. Patent Application Ser. No. 62/634,480, filed on Feb. 23, 2018, the disclosure of which is incorporated herein by reference in its entirety.

### BACKGROUND OF THE INVENTION

The present invention is generally directed to optical communications, and more specifically connecting elements at the end of optical fibers to enhance the coupling of light between fibers.

Optical communications systems use optical fibers to transport light signals. For longer distances, for example more than around one kilometer, optical signals are typically transmitted over a single mode fiber, i.e. a fiber which can support light propagating only along one fiber mode. Multimode fibers can be used over shorter distances, but the useful length of these types of fibers is limited due to mode dispersion. Single mode fibers are typically made of silica and carry signals typically in the range of around 1250 nm-1650 nm, which means that the diameter of the fiber core region is usually less than 10 μm. Such a small core diameter leads to strict alignment requirements when coupling light between the optical fiber and another fiber. Additionally, experience has shown that environmental factors can cause issues when the core diameter is so small. For example, a speck of dust aligned between the cores of two fibers can cause high optical coupling loss.

It has been found that the problems caused by such environmental factors can be reduced if the optical mode is expanded between fibers, i.e. where a “mode converter” is used. The fractional loss due to light hitting a speck of dust between fibers is reduced when the cross-sectional area of the optical beam between the fibers is larger. Also, the requirements of aligning one fiber to the other are easier to meet when the optical mode is larger. Current approaches to mode conversion include the use of collimating lenses or mirrors between fibers, which can be awkward to align in the field, or which require manual pre-alignment, which can be time-consuming and expensive. Another approach is to use a fiber with an integrated tapered end, but this is expensive to manufacture.

There is a need, therefore, to develop improved methods for mode conversion for optical fibers, which can be automated and, therefore, less expensive, and which can produce a product that is simple to assemble in the field.

### SUMMARY OF THE INVENTION

One embodiment of the invention is directed to an optical fiber unit that includes an optical fiber having a fiber core surrounded by fiber cladding. A fiber termination has a 3D-printed termination core is written over the end of the fiber. The termination core is surrounded by a termination cladding. The fiber termination has a first end facing the optical fiber and a second end facing away from the optical fiber. The termination core has a first diameter close to the first end of the fiber termination and a second diameter close to the second end of the fiber termination. The first diameter is different from the second diameter.

Another embodiment of the invention is directed to a method of forming a termination on the end of an optical fiber, where the optical fiber has a fiber core. The method includes writing a termination core at the end of the optical fiber using a 3D-printing process, the termination core being aligned with the fiber core. The diameter of the termination core is varied while writing the termination core so that a first end of the termination core, close to the end of the optical fiber, has a first diameter different from a second diameter at a second end of the terminal core opposite the first end of the terminal core.

Another embodiment of the invention is directed to a method of forming a termination on an end of at least a first optical fiber and a second optical fiber. The first and second optical fibers have respective first and second fiber cores. The method includes providing a support for the first optical fiber and providing a support for the second optical fiber. The method also includes writing a first termination core at the end of the first optical fiber using a 3D-printing process. The first termination core is aligned with the first fiber core. The method also includes writing a second termination core at the end of the second optical fiber using the 3D-printing process. The second termination core is aligned with the second fiber core. The diameters of the first and second termination cores are varied while writing the first and second termination cores.

The above summary of the present invention is not intended to describe each illustrated embodiment or every implementation of the present invention. The figures and the detailed description which follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIGS. 1A and 1B schematically illustrated optical fibers with a 3D-printed termination having a tapered core, according to embodiments of the present invention;

FIG. 2 schematically illustrates elements of a system used for ‘Dip in Laser Lithography’ (“DiLL”) suitable for fabricating a 3D-printed termination having a tapered core;

FIGS. 3A-3F schematically illustrate steps in the fabrication of a 3D-printed termination having a tapered core, according to an embodiment of the present invention;

FIGS. 4A and 4B present micrographs of an optical fiber having a 3D-printed termination with a tapered core, according to an embodiment of the present invention;

FIG. 5A presents a graph showing results of transmission simulations for a single mode optical fiber having a 3D-printed tapered core, according to embodiments of the present invention, as a function of taper length, for baseplates having a 10 μm thickness and various diameter;

FIG. 5B presents a graph showing results of transmission simulations for a single mode fiber having a 3D-printed tapered core, according to embodiments of the present invention, as a function of taper length, for baseplates having a 100 μm diameter and various thicknesses;

FIG. 5C presents a graph showing results of transmission simulations for a single mode fiber having a 3D-printed tapered core, according to embodiments of the present invention, as a function of taper length, without a baseplate and with a 10 μm thick baseplate having a 100 μm diameter;

FIG. 5D presents a graph showing the results of transmission simulations for a single mode fiber having a 3D-printed core, both with and without cladding, according to embodiments of the present invention;

FIGS. 6A-6E schematically illustrate optical fibers with 3D-printed termination having tapered core of various profiles, according to embodiments of the present invention; and

FIG. 7 schematically illustrates an approach to forming 3D-printed terminations having tapered cores on multiple optical fibers by aligning the multiple fibers in an alignment block, according to an embodiment of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

The present invention is directed to systems, devices, and methods that can provide benefits to optical communication networks. More particularly, the invention is directed to the use of optical cores added to the ends of the optical fibers via 3D printing. The use of 3D printing permits the fabrication of a core having a non-uniform diameter along its length. Thus, such a technique can be used to form a termination at the end of a fiber that includes a tapered core.

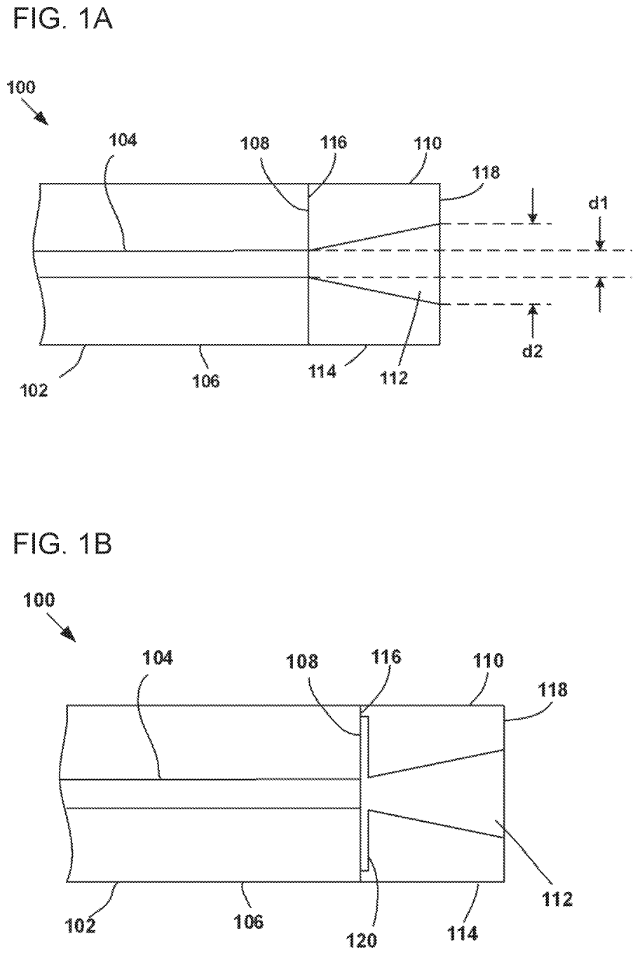

One example of a terminated optical fiber 100 is schematically illustrated in FIG. 1A. The terminated fiber 100 uses an optical fiber 102, for example a single mode optical fiber such as SMF-28 optical fiber available from Corning Inc., Corning N.Y. The optical fiber 102 is formed with a core 104 surrounded by a cladding 106 that has a refractive index less than that of the core 104. According to Corning's specifications, the SMF-28 fiber has a core diameter of 8.2 μm and a cladding diameter of 125 μm.

A fiber termination 110 is located at the end of the fiber 102. The fiber termination 110 is formed with a core 112 surrounded by a cladding 114. The fiber termination 110 has a first end 116 facing the fiber end 108, and a second end 118 on the other side facing away from the fiber 102. The diameter of the core 112 can change along its length. In the illustrated embodiment, the core 112 is tapered, so that the core diameter at the first end 116, d1, is smaller and the core diameter at the second end 118, d2, is larger.

In the embodiment illustrated in FIG. 1A, the core 112 has been directly printed on the end face 108 of the fiber 102, in alignment with the fiber core 104, so that light can pass from the fiber core 104 into the termination core 112. Another approach is illustrated in FIG. 1B, in which the core 112 is printed on a baseplate 120 which covers a larger area of the fiber end face 108 than just the core 112. The baseplate 120 may improve the adhesion of the core 112 to the fiber 102 during the 3D printing process, thus reducing the risk of the core 112 breaking off during the printing process or during subsequent handling and processing.

It should be noted that the embodiments illustrated in FIGS. 1A, 1B and some of the following figures, are not intended to show the optical fiber and its termination in correct scale, but are intended only to illustrate the relative positions of the various elements. As has been stated above, cladding diameter of the fiber 102 may be 125 μm and its core diameter around 8 μm. Also, the 3D-printed fiber termination 110 may be a few hundreds of microns in length, while the core diameter may be of the order of one to a few 10 s of microns. The actual dimensions of devices made using the techniques disclosed herein are discussed below.

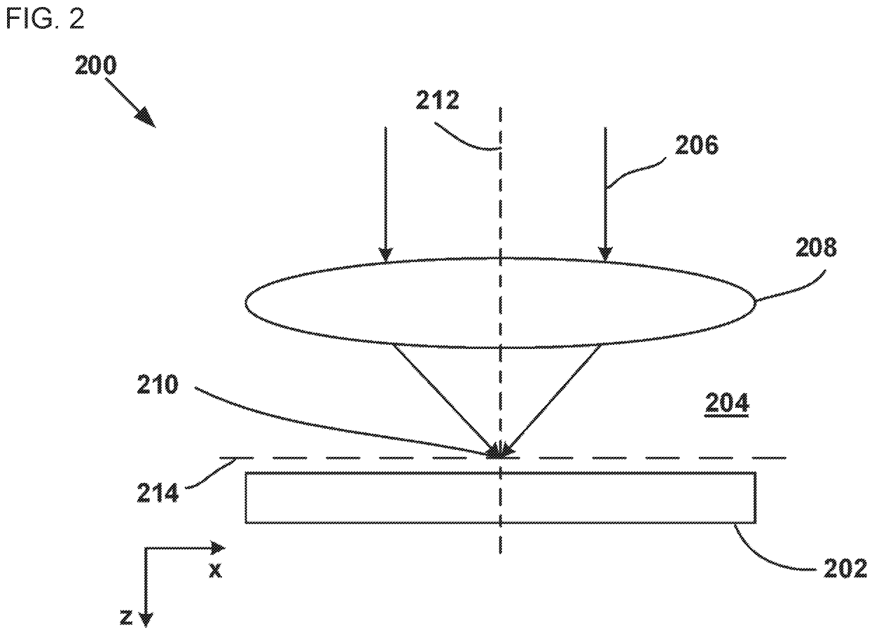

One type of 3D printing that is suitable for forming the fiber termination 110 is ‘Dip-in Laser Lithography’ (“DiLL”). FIG. 2A schematically illustrates a DiLL set up 200, in which a substrate 202, which is typically a polished surface e.g. the polished end of an optical fiber, is immersed in a photosensitive liquid 204. Light 206 from a light source, such as a femtosecond laser operating at around 780 nm, is focused by a lens unit 208, through the photosensitive liquid 204 to the focal point 210. In most cases, the volume between the lens unit 208 and the substrate 202 is filled with the photosensitive liquid 204. In the illustrated embodiment, the focal point 210 is at the intersection of the lens axis 212 and the focal plane 214. The photosensitive liquid 204 undergoes a multi-photon reaction with the light 206, in most cases a 2-photon reaction, to solidify. The correct selection of the optical power of the light 206 and the focusing properties of the lens unit 208 can, therefore, result in the volume where the photosensitive liquid 204 reacts with the light 206 being extremely small, and may be submicron in size. The substrate 202 can be moved in the x-y plane (the y-direction lies out of the plane of the figure) which, together with selective switching of the light 206, results in writing a layer of solidified material having a desired 2D pattern. The substrate 202 can then be moved in the z direction by an amount equal to about that of the thickness of the 2D pattern just printed, and another 2D layer can then be printed. In this manner, a 3D object can be formed by printing a number of sequentially written 2D layers. An advantage of DiLL, in which the photosensitive liquid 204 is solidified at a point between the substrate 202 and the lens unit 208 is that the height (z-direction) of the resulting 3D structure is not dependent on the focal length of the lens unit 208.

A system suitable for use in DiLL is the Photonic Professional GT 3D laser lithography system available from Nanoscribe GmbH, Eggenstein-Leopoldshafen, Germany. DiLL is further described in U.S. Pat. No. 9,302,430, incorporated herein by reference.

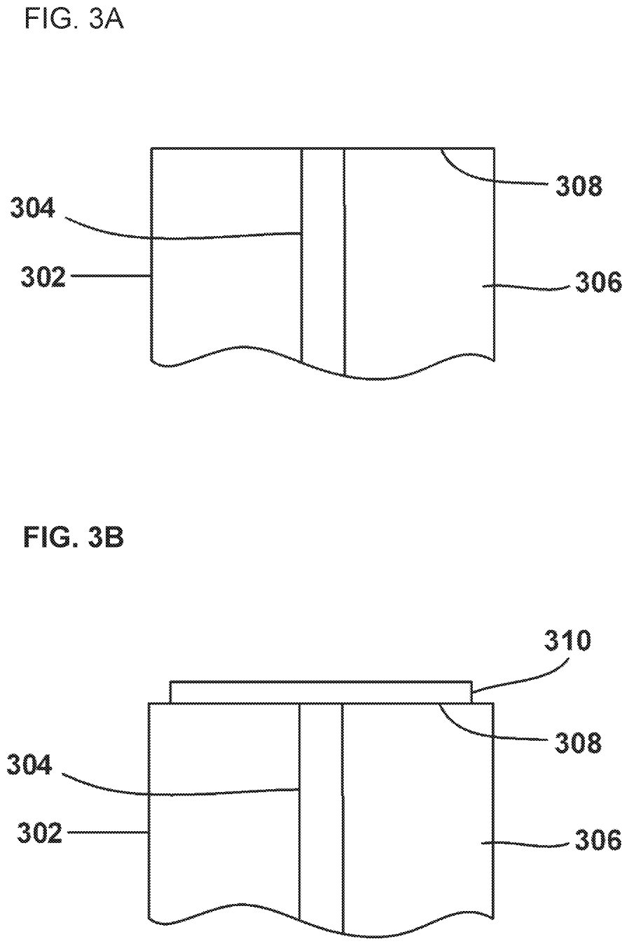

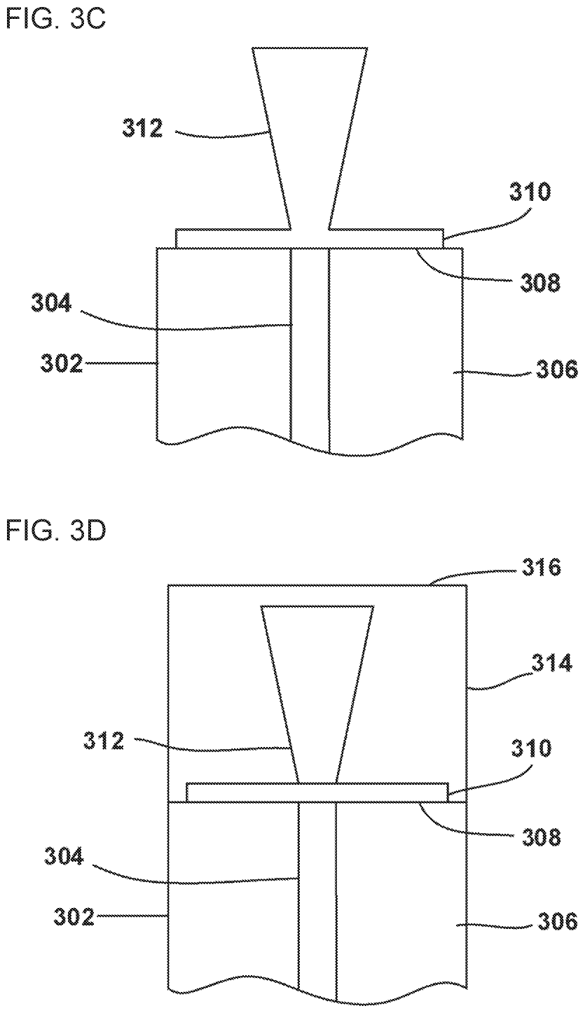

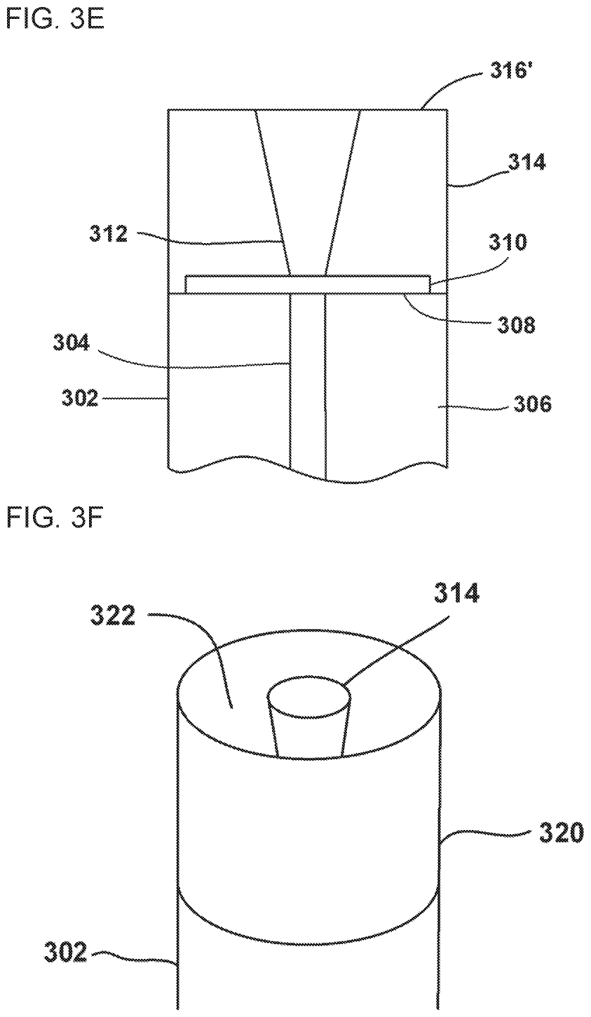

FIGS. 3A to 3E schematically illustrate steps in fabricating a 3D-printed fiber terminator. FIG. 3A shows an optical fiber 302, having a core 304 surrounded by a cladding. The fiber termination is to be formed on the fiber end 308. FIG. 3B shows the optical fiber 302 after a baseplate 310 has been formed on the fiber end 308, for example using DiLL to 3D print the baseplate 310. For 2-photon DiLL, the baseplate 310 may be formed from IP-DIP, a photosensitive liquid available from Nanoscribe GmbH. An adhesion promotor may be used for any 3D-printed element formed directly on the fiber end 308. For example, an adhesion promotor may be used between the fiber end 308 and the baseplate 310. The adhesion promotor may be any material suitable for such a purpose, for example, 3-(trimethoxysilyl)propyl methacrylate and vinyl phosphonic acid. An element is considered to be directly written on the fiber end even if an adhesion promoter is provided on the surface of the fiber end, between the fiber end and the baseplate or core.

FIG. 3C shows the optical fiber after a tapered core 312 has been formed on the baseplate 310. The tapered core 312 may be formed using DiLL via a 3D printing step. In other embodiments the tapered core 312 may be formed directly on the fiber end 308, without a baseplate 310. In such a case, an adhesion promotor is preferably used between the tapered core 312 and the fiber end 308.

FIG. 3D shows the fiber 302 after a cladding material 314 has been applied to surround the tapered core 312. The cladding material 314 has a refractive index less than that of the tapered core 312 so that light propagating out of the fiber 302 into the core 312 is confined to the core 312. The cladding material 314 may be a transparent photoresist having a refractive index less than that of the core 312. For example, a mixture of 85% IP-DIP/15% dipropylene glycol diacrylate (CAS 57472-68-1) has a refractive index of 1.51, compared to 1.52 of IP-DIP. In another example, a mixture of 89% IP-DIP/89% Genomer 4425 (a curable aliphatic urethane oligomer obtainable from Rahn AG, Switzerland) has a refractive index of 1.51. The cladding material 314 may be applied using any suitable process. For example, the cladding material may be applied using DiLL, or some other process such as molding and UV-curing (single-photon polymerization) of photosensitive material. In another approach, the cladding may be produced, after the core has been written, using a 2-photon 3D-printing process with a photosensitive material having a lower refractive index than that used for the core.

In some cases, the outer face 316 of the cladding material 314 may extend beyond the end of the tapered core 312, as shown in FIG. 3D the figure. The outer face 316 may then be polished down to remove excess cladding material 314 beyond the end of the tapered core 312, as shown in FIG. 3E.

In another approach to providing the cladding material 314, a cylindrical container 320 may be formed around the outside of the fiber end a DiLL step like that used to print the termination core 312, forming a space 322 between the core 314 and the container 320, for example as shown in FIG. 3F. The space 322 may subsequently be filled with another photosensitive material that can then be cured in situ, for example using a single photon UV flood exposure.

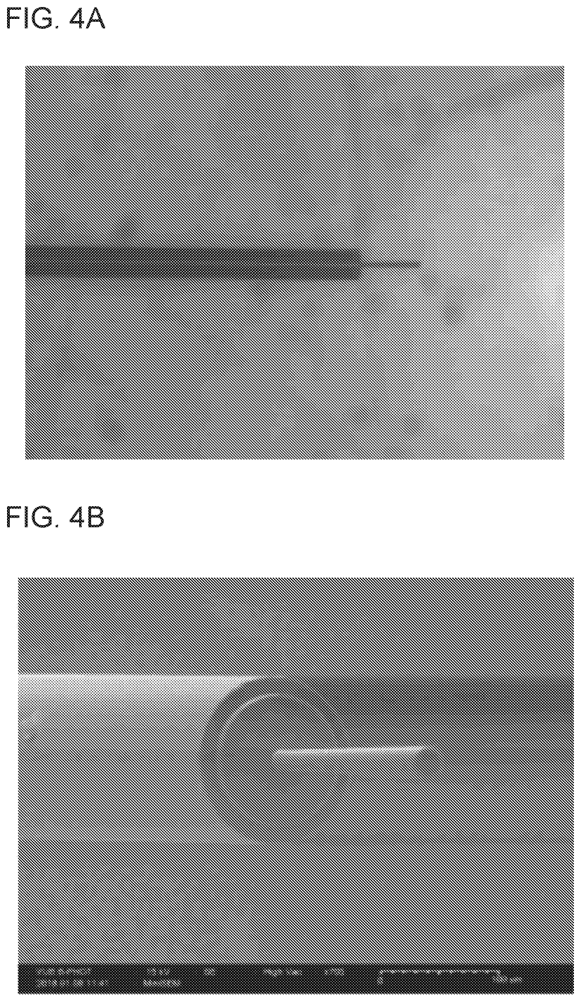

FIGS. 4A and 4B show micrographs of a baseplate and tapered core printed on the end of an SMF-28 optical fiber. The baseplate diameter was 100 μm: its edge can be seen in FIG. 4B as the ring on the end of 125 μm diameter fiber. The tapered core had length of 241.4 μm. Its diameter varied from 15.1 μm at the baseplate to around 24.5 μm at its output, a mode area ratio of about 3. The baseplate and tapered core were formed of IP-DIP.

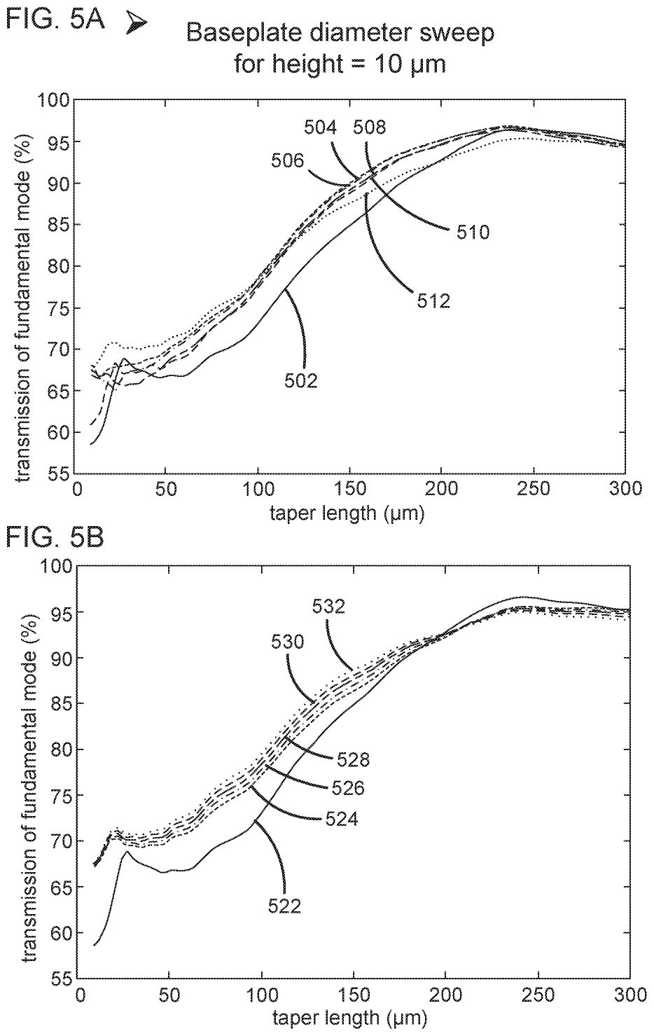

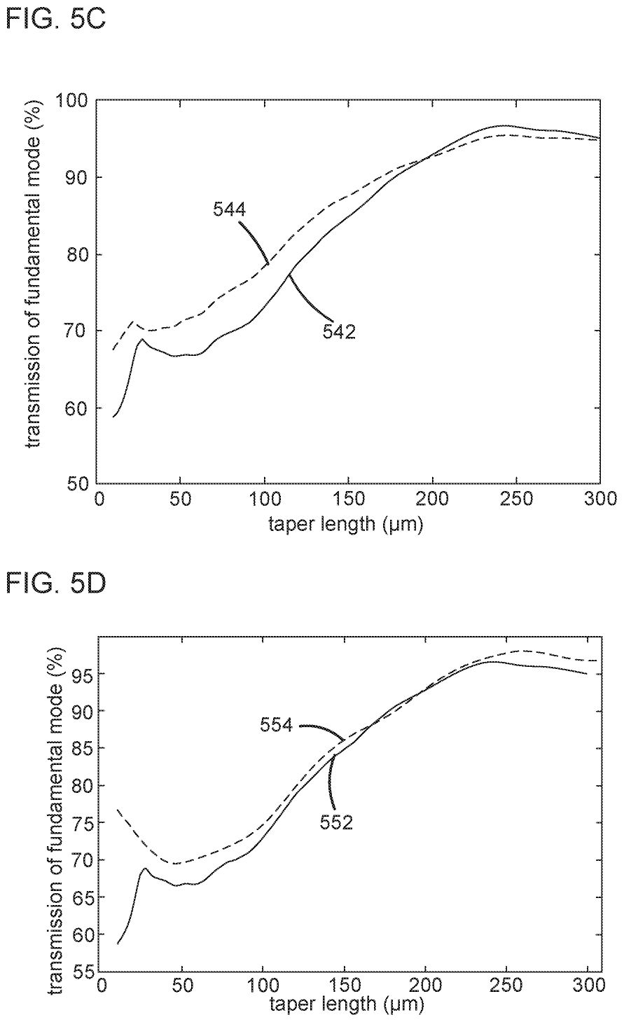

Baseplate size, both diameter and height, and tapered core height can all affect the amount of light that is transmitted from a fiber and out of the tapered core. Simulations were carried out to estimate the transmission loss experienced by light, at 1550 nm, propagating from a single mode fiber through a linearly tapered core having an input diameter of 15.1 μm and an output diameter of 24.5 μm (mode area expansion factor of three). The refractive index for the tapered core was assumed to be 1.53, the refractive index for cured IP-DIP. Unless otherwise stated, the transmission simulations assumed the tapered core had no cladding. FIG. 5A presents the transmission results for baseplates of various diameter, as a function of taper length. The baseplate height was set at 10 μm. Curve 502 represents the calculated loss where there is no baseplate. Curve 504 corresponds to a baseplate diameter of 20 μm, curve 506 to a baseplate diameter of 40 μm, curve 508 to a baseplate diameter of 60 μm, curve 510 to a baseplate diameter of 80 μm and curve 512 to a baseplate diameter of 100 μm. It will be understood that transmission losses can increase if the refractive index of the material written on the surface of the fiber end is not the same as the refractive index as the fiber core and, therefore, to reduce transmission losses, the baseplate and tapered core material preferably have the same refractive index as the fiber core. Also, the increased losses at shorter taper lengths likely are caused by the taper being non-adiabatic.

FIG. 5B presents the results of the calculated transmission for baseplates of fixed diameter (100 μm) and varying height, as a function of taper length. Curve 522 represents the calculated loss where there is no baseplate. Curve 524 corresponds to a baseplate height of 5 μm, curve 506 to a baseplate height of 7.5 μm, curve 528 to a baseplate height of 10 μm, curve 530 to a baseplate height of 12.5 μm and curve 532 to a baseplate height of 15 μm.

FIG. 5C shows the calculated transmission as a function of taper length with no baseplate, curve 542, and with a baseplate having a height of 10 μm and diameter of 100 μm, curve 544. Above about 195 μm, the tapered core without the baseplate shows lower loss, with the highest transmission (96.54%) being found at a length of about 241 μm. For the tapered core with the baseplate, the highest transmission (95.34%) was obtained at a core length just less than 241 μm. Accordingly, there is some variation in transmission as a function of the baseplate size, and so it will be appreciated that, for a particular design of tapered core, the baseplate size may have to be optimized to reduce transmission loss.

FIG. 5D shows the calculated transmission loss for a linearly tapered core, as a function of taper length, without a cladding, curve 552, and with a cladding, curve 554. The refractive index of the cladding was assumed to be 1.50. The cores were assumed to have no baseplate. The tapered core with cladding had an input diameter of 13.4 μm and an output diameter of 23.2 μm, for a mode area expansion factor of three. The transmission through the core without cladding was calculated to peak at about 96.5% at a taper length of 241.4 μm. The transmission through the core that had a cladding was calculated to peak of about 98%, at a taper length of 261.6 μm.

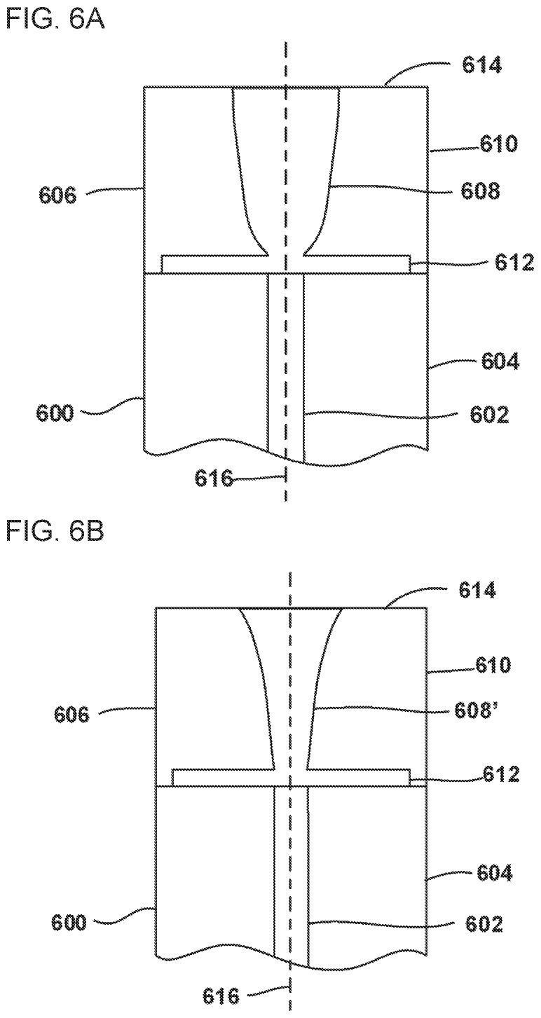

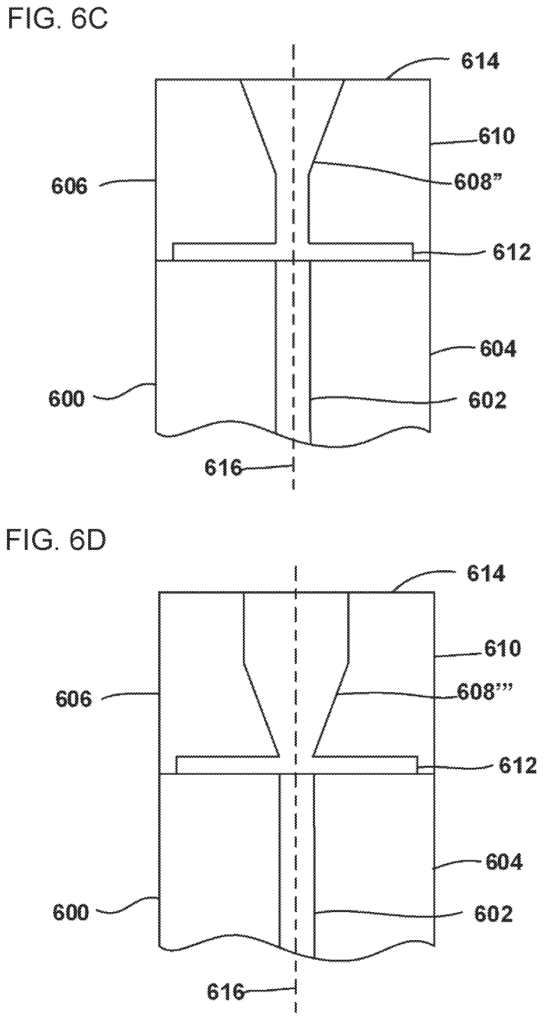

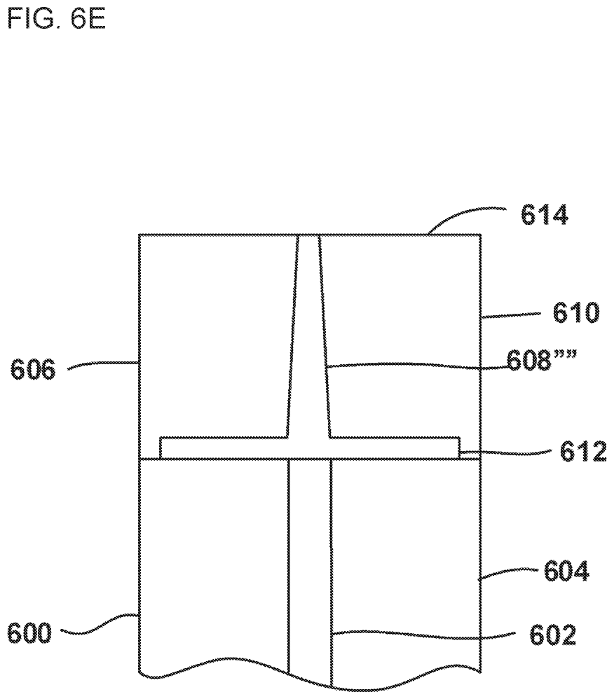

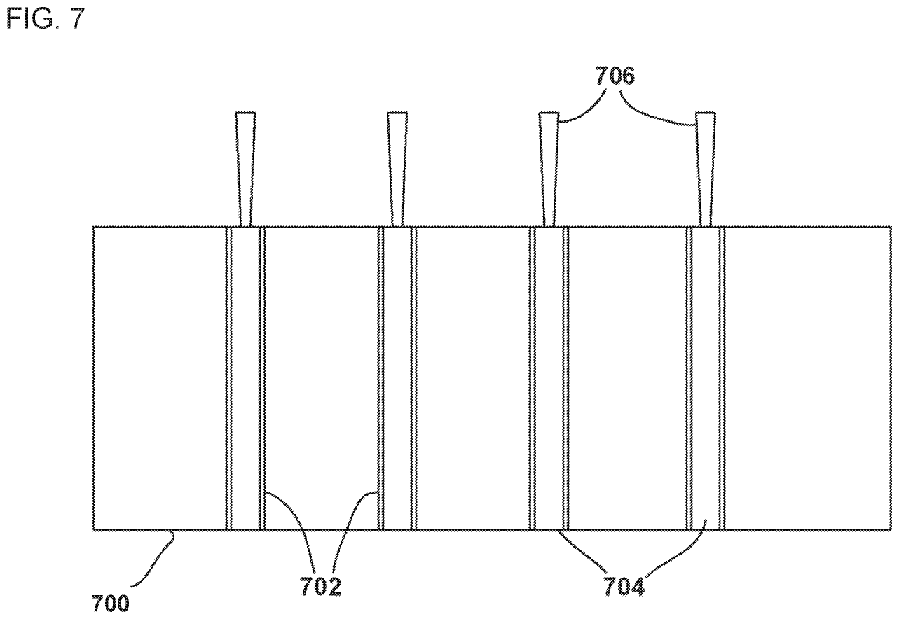

There is no requirement that the core have a positive linear taper, i.e. increasing in diameter from the fiber end to the output end. The taper may be nonlinear or some combination of linear and nonlinear, or may be negative, in which the core diameter is largest closer to the fiber. FIG. 6A shows an exemplary embodiment of a fiber 600 having a core 602 surrounded by a cladding 604. The fiber 600 is provided with a termination 606 that has a core 608 within a cladding 610. The core 608 is set on a baseplate 612. In this embodiment, the core 608 has a non-linear profile, which may be parabolic. In this embodiment, the slope of the interface between the core 608 and the cladding 610 is greater closer to the output end 614. Here, the “slope” is highest when it is parallel to the axis 616.

FIG. 6B shows another exemplary embodiment in which the slope of the interface between the core 608′ and the cladding 610 closer to the output face 614 is less than the slope closer to the fiber 600. The termination core 608′ in this case may have a diameter that expand exponentially with distance from the fiber 600.

The termination core 608 may also include a linear portion. For example, in the embodiment schematically illustrated in FIG. 6C, the termination core 608″ has a linear portion closer to the fiber 600. The linear portion is parallel to the fiber axis 616 and is coupled to a tapered portion that is closer to the output end 614. In another example, schematically illustrated in FIG. 6D, the termination core 608′″ has a tapered portion closer to the fiber 600 and a linear portion, which is parallel to the axis 616, closer to the output end 614.

In other embodiments, the diameter of the termination core at the output end may be less than the diameter of the fiber core. An embodiment of such a termination is schematically illustrated in FIG. 6E. In this case, the core 608″ is linearly tapered to have a smaller diameter at the output face 614 than at the baseplate 612. Such an embodiment may find use, for example, in coupling between a silica fiber having a relatively large core, for example of the order of 8-9 μm, to a silicon or silicon nitride waveguide on a chip, which typically has a narrower width, for example around 3-4 μm.

The 3D printing process may be set up to handle multiple fibers and may be automated, thus reducing the cost and time to prepare printed fiber terminations. In an example schematically illustrated in FIG. 7, an alignment block 700 is provided with a number of v-grooves 702 for support of respective fibers 704. The alignment block 700 orients the fibers 704 so that termination cores 706 may be written onto the ends of the fibers 704. In the illustrated embodiment, the cores 706 are provided without baseplates, but that is not a necessary condition, and they could be provided with baseplates. Furthermore, the alignment block 700 is not limited to the four fibers shown in FIG. 7, but may accommodate any suitable number of fibers, for example 8, 16 or 32. Such an alignment block may be used, for example, in providing 3D-written terminations to fibers in a fiber ribbon. Termination cladding may be provided around the termination cores 706 in the same manner as described above with reference to FIGS. 3D and 3E.

Various modifications, equivalent processes, as well as numerous structures to which the present invention may be applicable will be apparent to those of skill in the art to which the present invention is directed upon review of the present specification. The claims are intended to cover such modifications and devices. For example, the baseplate and tapered core need not be formed of the same material. However, if they are not formed of the same material, then transmission losses may increase if they do not have the same refractive index.

As noted above, the present invention is applicable to optical systems for communication and data transmission. Accordingly, the present invention should not be considered limited to the particular examples described above, but rather should be understood to cover all aspects of the invention as fairly set out in the attached claims.

What we claim as the invention is:

1. An optical fiber unit, comprising:
an optical fiber having a fiber core surrounded by fiber cladding, the optical fiber having a fiber end; and
a fiber termination comprising a 3D-printed termination core written over the fiber end, the termination core being surrounded by a termination cladding, the fiber termination having a first end facing the optical fiber and a second end facing away from the optical fiber;
wherein the termination core has a first diameter close to the first end of the fiber termination and a second diameter close to the second end of the fiber termination, the first diameter being different from the second diameter.

2. An optical fiber unit as recited in claim 1, wherein the termination core is written directly on the fiber end.

3. An optical fiber unit as recited in claim 1, wherein the fiber termination further comprises a baseplate at the first end, the baseplate being written directly on the fiber end, a first side of the baseplate facing the optical fiber and a second side of the baseplate facing away from the optical fiber, the termination core being coupled to the second side of the baseplate.

4. An optical fiber unit as recited in claim 3, wherein the baseplate is formed of a first material and the termination core is formed of the first material.

5. An optical fiber unit as recited in claim 3, wherein the baseplate is formed of a first material and the termination core is formed of a second material different from the first material.

6. An optical fiber unit as recited in claim 1, wherein the first diameter of the termination core is less than the second diameter of the termination core.

7. An optical fiber unit as recited in claim 1, wherein the first diameter of the termination core is greater than the second diameter of the termination core.

8. An optical fiber unit as recited in claim 1, wherein the termination core expands linearly from the first end of the fiber termination to the second end of the fiber termination.

9. An optical fiber unit as recited in claim 1, wherein the termination core expands nonlinearly from the first end of the fiber termination to the second end of the fiber termination.

10. An optical fiber unit as recited in claim 1, wherein at least a part of the termination core is parallel to an axis of the optical fiber.

11. A method of forming a termination on an end of an optical fiber, the optical fiber having a fiber core, comprising:
writing a termination core at the end of the optical fiber using a 3D-printing process, the termination core being aligned with the fiber core; and
varying a diameter of the termination core while writing the termination core so that a first end of the termination core, close to the end of the optical fiber, has a first diameter different from a second diameter at a second end of the terminal core opposite the first end of the terminal core.

12. A method as recited in claim 11, further comprising providing a termination cladding around the termination core.

13. A method as recited in claim 12, wherein providing the termination cladding comprises forming cladding material over the second end of the terminal core, and further comprising removing the cladding material over the second end of the terminal core.

14. A method as recited in claim 11, further comprising writing a baseplate using 3D-printing on the end of the optical fiber before writing the termination core.

15. A method as recited in claim 11, wherein varying the diameter of the termination core results in the first diameter being less than the second diameter.

16. A method as recited in claim 11, wherein varying the diameter of the termination core results in the first diameter being greater than the second diameter.

17. A method of forming a termination on an end of at least a first optical fiber and a second optical fiber, the first and second optical fibers having respective first and second fiber cores, comprising:
providing a support for the first optical fiber;
providing a support for the second optical fiber;
writing a first termination core at the end of the first optical fiber using a 3D-printing process, the first termination core being aligned with the first fiber core;
writing a second termination core at the end of the second optical fiber using the 3D-printing process, the second termination core being aligned with the second fiber core; and
varying diameters of the first and second termination cores while writing the first and second termination cores.

18. A method as recited in claim 17, wherein, after writing the first and second termination cores, a first end of the first termination core, close to the end of the first optical fiber, has a first diameter different from a second diameter at a second end of the first termination core opposite the first end of the first termination core, and a first end of the second termination core, close to the end of the second optical fiber, has a first diameter different from a second diameter at a second end of the second termination core opposite the first end of the second termination core.

19. A method as recited in claim 17, further comprising providing a baseplate between at least one of i) the end of the first optical fiber and the first termination core and ii) the end of the second optical fiber and the second termination core.
